(19) United States
(12) Patent Application Publication
(10) Pub. No.: US 2010/0333146 A1
(43) Pub. Date: Dec. 30, 2010

(54) Vehicle infotainment system and method for entertaining passengers in a rear portion of a vehicle

(75) Inventors: Gary Pickney, Peachtree City, GA (US); Anthony Schmits, Sharpsburg, GA (US)

Correspondence Address: PANASONIC AUTOMOTIVE SYSTEM;COMPANY OF AMERICA, 776 HWY 74 SOUTH, PEACHTREE CITY, GA, 30269, US

(73) Assignee: Panasonic Automotive Systems Company of America Division of Panasonic Corporation of North America, Peachtree City, GA (US)

(21) Appl. No.: 12/459,340

(22) Filed: Jun. 29, 2009

(51) Int. Cl. H04N 7/18; G06F 3/041; H04N 5/64; H04B 1/00

(52) U.S. Cl. 725/75; 345/173; 715/717; 348/E05.128; 348/837; 348/E05.122; 381/86; 386/E05.003

(57) ABSTRACT

An infotainment system includes a rear entertainment system hub assembly disposed within the rear portion of the interior space of the vehicle. The rear entertainment system hub assembly includes a plurality of entertainment platforms, each adapted to receive and process a respective entertainment medium. The plurality of entertainment platforms is configured to generate at least one audio output signal and at least one video output signal. A user interface is communicatively coupled to the plurality of entertainment platforms and includes a touch-screen display unit adapted to receive user commands. The user interface selects and controls the plurality of entertainment platforms according to the user commands. A plurality of audio output speakers is communicatively coupled to the rear entertainment system hub assembly and receives the audio output signal. At least one video display unit is disposed within the rear portion of the interior space and receives the video output signal.

### BACKGROUND OF THE INVENTION

1. Field of the Invention

The present invention relates to vehicle entertainment systems and methods for entertaining passengers in a vehicle.

2. Description of the Related Art

Many passenger vehicles, such as vans, minivans, sport utility vehicles, station wagons, sedans and coupes, have rear seating designed to accommodate passengers in the rear portion of the vehicle. It is often desirable to provide the rear passengers in such vehicles with entertainment, particularly on long trips. Accordingly, many such vehicles are equipped with entertainment platforms or applications such as video display units, digital video disk (DVD) players, CD players and radios, which may be enjoyed from the rear seats of the vehicle. However, such platforms or applications are typically positioned and operated from the front console of the vehicle, thereby making it difficult for the rear passengers to control the platforms/applications. In some cases, the vehicle includes a remote control unit operable from the rear of the vehicle, which enables the rear passengers to control certain features. Nevertheless, these remote control units are limited in the amount of control provided the rear passenger.

In addition, it is desirable to provide rear passengers with a variety of entertainment platforms and unfettered control over the operation of those platforms. Current vehicle entertainment systems are limited in entertainment platforms and provide the rear passenger with only limited control over the platforms. It is also desirable to concurrently provide different rear passengers with different forms of entertainment. Current rear entertainment systems typically provide only one form of entertainment to all of the rear passengers.

Many passenger vehicles also include navigational systems that inform the driver of the current location of the vehicle and directions for reaching the desired destination. Such navigational systems traditionally include a display unit for displaying a map of the vehicle's travel. Unfortunately, such a display unit is inaccessible and difficult to view by the rear passengers. In many cases, it would be beneficial for a passenger to view and operate the navigational system while the driver operates the vehicle.

It would be beneficial to provide a rear entertainment system and method that provides rear passengers with a variety of different entertainment options and the ability to control those options.

### SUMMARY

The present invention provides vehicle infotainment systems and methods for entertaining passengers in the rear portion of the vehicle. In one embodiment, the infotainment system includes a rear entertainment system hub assembly disposed within the rear portion of the interior space of the vehicle. The rear entertainment system hub assembly includes a plurality of entertainment platforms, each receiving and processing a respective entertainment medium. The plurality of entertainment platforms is configured to generate at least one audio output signal and at least one video output signal. A user interface is communicatively coupled to the plurality of entertainment platforms and includes a touch-screen display unit adapted to receive user commands. The user interface selects and controls the plurality of entertainment platforms according to the user commands. A plurality of audio output speakers is communicatively coupled to the rear entertainment system hub assembly and receives the audio output signal. At least one video display unit is disposed within the rear portion of the interior space and receives the video output signal.

In another aspect, the invention provides a method for providing in-vehicle entertainment to rear passengers of a vehicle. The method includes the steps of installing a rear entertainment system hub assembly within a rear portion of an interior space of the vehicle, equipping the rear entertainment system hub assembly with a plurality of entertainment platforms each receiving and processing a respective type of entertainment medium, equipping the rear entertainment system hub assembly with a user interface communicatively coupled to the plurality of entertainment platforms and receiving user commands, using the rear entertainment system hub assembly to select and control the plurality of entertainment platforms according to the user commands, using the rear entertainment system to independently and simultaneously operate first and second ones of the plurality of entertainment platforms in response to the user commands, and to generate first and second audio/video output signals from the respective operation of the first and second simultaneously operating entertainment platforms, each of the first and second audio/video output signals comprising at least one of an audio signal and a video signal, communicatively coupling first and second audio/video output units to the rear entertainment system hub assembly, the audio/video output units comprising a video display monitor, an audio speaker, and/or an audio headphone set, and using the rear entertainment system hub assembly to send the first audio/video output signal to the first audio/video output unit and the second audio/video output signal to the second audio/video output unit.

In still another aspect, the method for providing in-vehicle entertainment to rear passengers of a vehicle includes the steps of installing a rear entertainment system hub assembly within a rear portion of an interior space of the vehicle, equipping the rear entertainment system hub assembly with a plurality of entertainment platforms each receiving and processing a respective type of entertainment medium, equipping the rear entertainment system hub assembly with a touch-screen user interface communicatively coupled to the plurality of entertainment platforms and receiving user commands, using the rear entertainment system hub assembly to select and control the plurality of entertainment platforms according to the user commands, using the rear entertainment system to generate at least one audio output signal and at least one video output signal in response to the user commands, communicatively coupling a plurality of audio output speakers to the rear entertainment system hub assembly, providing at least one video display unit within the rear portion of the interior space of the vehicle, communicatively coupling the at least one video display unit to the rear entertainment system hub assembly, equipping the rear entertainment system hub assembly with a wireless communication module, and transferring information between the rear entertainment system hub assembly and a personal electronic device external to the vehicle using the wireless communication module.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

FIG. 1 is a diagram of a vehicle equipped with an infotainment system in accordance with one embodiment of the present invention;

FIG. 2 is a diagram of a user interface of an infotainment system in accordance with another embodiment of the present invention and displaying a Main Menu;

FIG. 2A is a diagram of the user interface of FIG. 2 displaying another menu;

FIG. 2B is a diagram of the user interface of FIG. 2 displaying yet another menu;

FIG. 3 is a diagram of the user interface of FIG. 2 displaying another menu;

FIG. 3A is a diagram of the user interface of FIG. 2 displaying another menu;

FIG. 4 is a diagram of the user interface of FIG. 2 displaying another menu;

FIG. 4A is a diagram of the user interface of FIG. 2 displaying yet another menu;

FIG. 5 is a flow chart illustrating communication with the rear entertainment system hub assembly of an infotainment system in accordance with one embodiment of the present invention;

FIG. 6 is a front perspective view of a user interface of an infotainment system in accordance with one embodiment of the present invention; and

FIG. 7 is a plan view of one embodiment of a hub assembly and hub assembly mounting bracket of the present invention.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

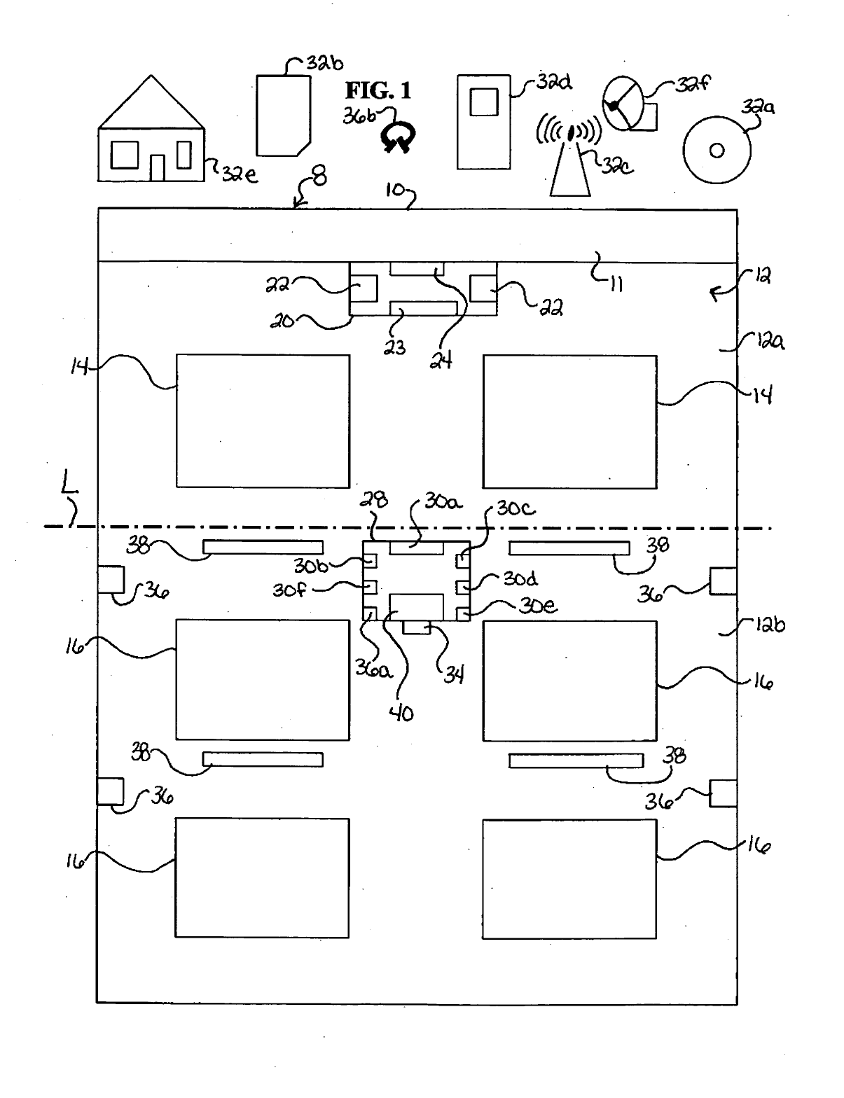

Referring first to FIG. 1, a vehicle 8 equipped with an infotainment system in accordance with one embodiment of the present invention is illustrated. Vehicle 8 generally includes vehicle body 10, which defines interior space 12. Interior space 12 includes forward portion 12a, disposed forward of line L, and rear portion 12b disposed rearward of forward portion 12a and line L. It should be understood that line L is used merely to visually distinguish between forward and rear portions 12a, 12b and that line L may be alternatively located. Vehicle 8 also includes front seating 14, disposed in forward portion 12a of interior space 12, and rear seating 16, disposed in rear portion 12b of interior space 12. Dashboard 11 is disposed in forward portion 12a and extends along the front interior of vehicle body 10. Entertainment console 20 is mounted in dashboard 11 and includes entertainment applications 22, which are adapted to receive and playback entertainment media. For instance, entertainment applications 22 may include a CD player, AM/FM radio receiver and/or satellite radio receiver. Console 20 also includes climate control system 24, which is adapted to control heating and air conditioning systems of vehicle 8. Console 20 also includes application controls 23, which allow the user to control entertainment applications 22 and climate control system 24.

In rear portion 12b of interior space 12, there is disposed a rear entertainment system. As is discussed in further detail below, the rear entertainment system generally includes hub assembly 28 and user interface 34, communicatively coupled to hub assembly 28. Hub assembly 28 allows passengers in rear seating 16 to select, operate and control the rear entertainment provided to passengers in rear seating 16.

Hub assembly 28 generally includes a plurality of entertainment platforms 30a-30f, which are communicatively coupled to user interface 34. Each of entertainment platforms 30a-30f is configured to receive, process and/or playback a respective entertainment medium, such as entertainment media 32a-32f. For instance, entertainment platforms 30a-30f include digital video disk (DVD)/compact disk (CD) player(s) 30a, which is configured to receive DVD(s) or CD(s) 32a and process/playback information stored on DVD/CD(s) 32a. Player 30a may be configured to receive and simultaneously process multiple DVDs and/or CDs. Entertainment platform 30b is in the form of a secure digital (SD) memory card port 30b, which is configured to receive a SD memory card 32b and process/playback data stored on SD memory card 32b. Entertainment platform 30c is an AM/FM radio receiver 30c, which is adapted to receive and process signals from AM/FM radio transmitter 32c. Entertainment platform 30d is a connector port for communicatively coupling to iPod® 32d, or similar mP3 storage device, and processes data stored on iPod® 32d. Entertainment platform 32e is a wireless communications module, such as a WiFi or Bluetooth communications module. Wireless communication module 32e is configured to communicate and exchange information with a remote device, such as a home computer, cell phone, remote server or other personal electronic device that is disposed external to vehicle 8, thereby enabling the downloading or uploading of information between the remote device and hub assembly 28. Entertainment platforms 30a-30f also include satellite receiver 30f, which is adapted to communicate with satellite 32f, such as a global positioning satellite GPS and/or satellite digital audio radio service (SDARS) satellite. Entertainment platforms 30a-30f are adapted to operate independently of, and simultaneously with, one another such that, as described in further detail below, each of rear passengers may select and enjoy a different one of entertainment media 32a-32f.

It should be understood that entertainment platforms 30a-30f shown in this embodiment are intended to be illustrative. An infotainment system of the present invention may include other entertainment platforms in addition, or in the alternative, to those illustrated thus far. For instance, entertainment platforms may include a flash drive port; USB port; docking stations for cameras, cell phones, personal data assistants (PDA) or other media storage devices; audio/video jacks; and/or high definition multimedia interface (HDMI) port. Entertainment platforms 30a-30f are configured to generate at least one audio output signal and at least one video output signal and, in some cases as described in further detail below, may be configured to simultaneously generate multiple, independent audio and video output signals. In addition, hub assembly 28 may be communicatively coupled to console 20 and entertainment applications 22 and climate control system 24 therein, to allow control of entertainment applications 22 and/or climate control system 24 from hub assembly 28.

User interface 34 is communicatively coupled to entertainment platforms 30a-30f and is adapted to operate and control entertainment platforms 30a-30f. User interface 34 is configured to receive commands from a user and may be in any form capable of receiving user commands. For instance, user interface 34 may include buttons, knobs, keypad, touch pad and/or keyboard. As discussed in further detail below, in one embodiment, user interface 34 includes a touch screen display unit. In this embodiment, user interface 34 is configured to display a menu of options on the touch screen display unit. The user controls entertainment platforms 30a-30f and navigates through the menu by touching the options displayed on the menu on touch screen display 34.

Referring still to FIG. 1, rear entertainment system hub assembly 28 may also include navigational display unit and platform 40. Navigational display unit 40 is adapted to communicate with a global positioning satellite (GPS) via either wireless communication module 32e or an other wireless communication device. For instance, navigational display unit 40 may be communicatively coupled to a wireless communication module in console 20, or may be equipped with a separate, dedicated wireless communication module. Navigational display unit 40 is adapted to receive signals from a GPS and display navigational information, such as vehicle location, vehicle destination, maps and road conditions.

Navigational display unit 40 may include a navigational interface component to allow a rear passenger to operate and direct the navigational information displayed on display unit 40. For instance, display unit 40 may be in the form of a touch screen or may include buttons, knobs or other control features. Additionally, or alternatively, user interface 34 may be communicatively coupled to navigational display unit 40 and may be adapted to control and direct the information displayed on display unit 40, based on user commands.

The vehicle infotainment system also includes audio output speakers 36 mounted in interior space 12 of vehicle 8 and communicatively coupled to rear entertainment system hub assembly 30. Audio output speakers 36 are adapted to receive audio output signals from hub assembly 30 and project sound into interior space 12 in response to audio output signals. The vehicle infotainment system may also include wireless infrared (IR) communication module 36a, which is configured to communicate audio output signals generated by entertainment platforms 30a-30f to wireless headphones 36b or other wireless audio device. The vehicle infotainment system also includes video display units 38 mounted in interior space 12 and communicatively coupled to hub assembly 30. Video display units 38 are adapted to receive video output signals from hub assembly 30 and display images in response to the video output signals. Although the illustrated embodiment shows multiple video display units 38, an infotainment system in accordance with the present invention may include a single video display unit.

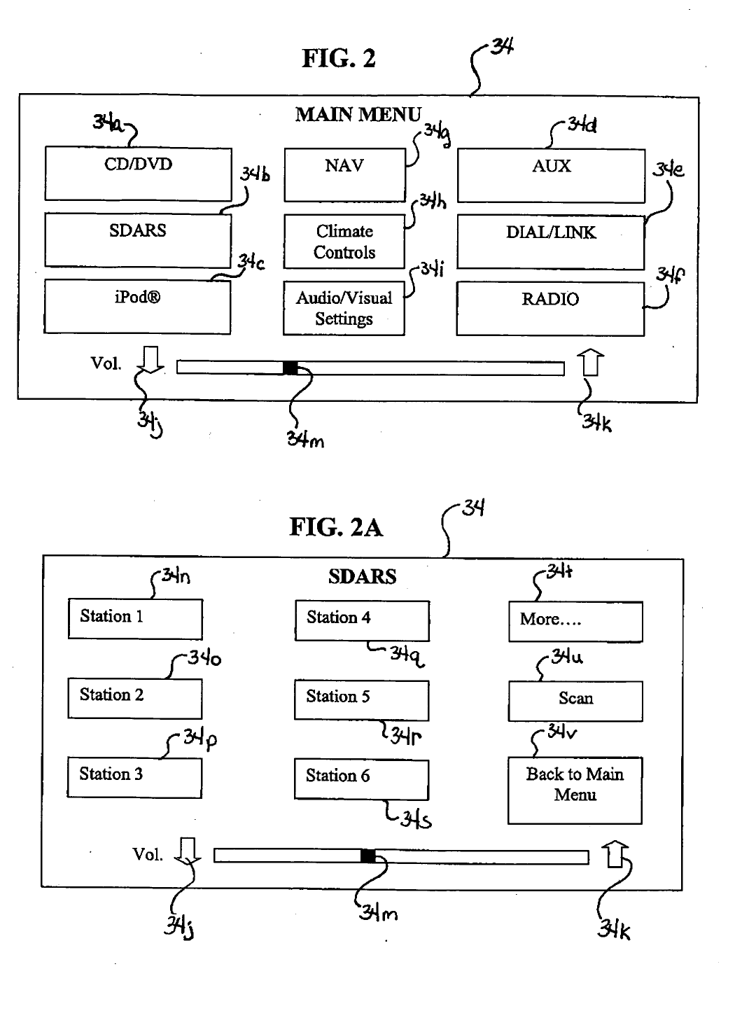

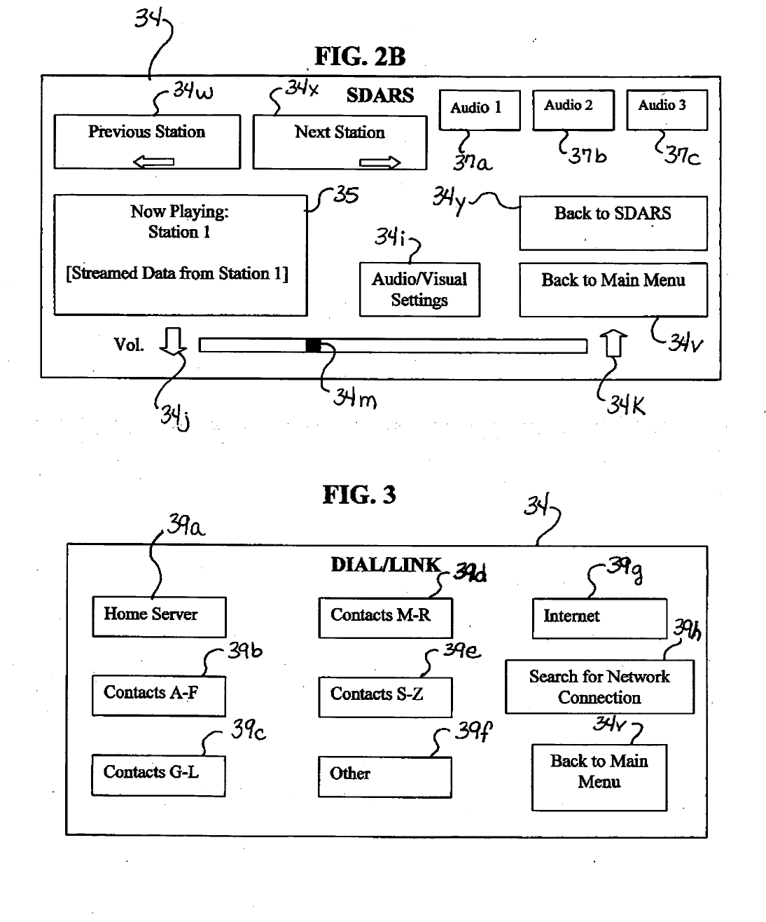

Referring now to FIGS. 2 and 2A-2B, the operation of an infotainment system in accordance with an embodiment of the present invention will now be described. For illustrative purposes, we assume that passengers in rear seating 16, desire to listen to satellite radio. Passengers access user interface 34 and use user interface 34 to select and control the satellite radio features. As illustrated in FIGS. 2 and 2A-2B, user interface 34 is in the form of a display unit having a touch screen. Touch screen 34 is configured to initially display a Main Menu, as shown in FIG. 2. The Main Menu displays a touch button for each of entertainment platforms 30a-30f (FIG. 1) available for selection. For instance, the Main Menu displayed on user interface 34 includes touch button 34a corresponding to CD/DVD platform 30a, touch button 34b corresponding to satellite digital audio radio service (SDARS) 30f, touch button 34c for the iPod® platform 30d, touch button 34d corresponding to auxiliary features such as SD memory card platform 30b, touch button 34e for the data/link (wireless communication module) feature 30e, and touch button 34f for standard AM/FM radio platform 30c.

The Main Menu illustrated in FIG. 2 may also include touch buttons 34g, 34h and 34i for accessing and controlling the navigational system platform 40, climate control platform 24 and audio/visual settings, respectively. The Main Menu may also include touch button controls 34j, 34k, 34m for adjusting the volume of the audio output, so that the user may adjust the volume at any time during the menu navigation process. Volume button 34j decreases the volume and button 34k increases the volume. As the volume is increased or decreased, indicator/button 34m moves along the indicator bar. Indicator button 34m may also be in the form of a touch button such that the user may adjust the volume by touching indicator button 34m and sliding indicator button 34m along an indicator bar.

Assuming that the user wishes to engage the satellite digital audio radio service (SDARS), the user would touch SDARS button 34b on touch screen 34, which initiates communication between satellite receiver 30f and satellite 32f. User interface 34 then displays the SDARS menu, illustrated in FIG. 2A, which includes a set of touch buttons 34n-34v. Touch buttons 34n-34s correspond to the first six stations available from SDARS. The SDARS menu may be configured such that the station identification information for each station also appears on corresponding touch buttons 34n-34s. The SDARS menu may also include a More Selections button 34t for viewing the next six stations available from SDARS, a Scan button 34u for scanning all the available stations, and a Back to Main Menu button 34v for returning to the Main Menu screen shown in FIG. 2. The user selects the desired station, in this example station 1, by touching station 1 button 34n on touch screen 34. The selection of station 1 causes satellite receiver 30f (FIG. 1) to receive audio streaming data of station 1 from satellite transmitter 32f (FIG. 1), and cause user interface 34 to display the SDARS menu shown in FIG. 2B. This menu may include buttons displayed on the previous menu, such as the Audio/Visual settings button 34i, volume control buttons 34j, 34k, 34m, and Back to Main Menu button 34v. This menu may also include touch buttons such as Previous and Next Station buttons 34w, 34x, for scrolling through the satellite radio stations. This menu may also include a Now Playing information or display box 35, which displays the selected station information and, if available, data streamed from the selected station, such as song title and song artist.

The menu shown in FIG. 2B may also include audio destination buttons 37a-37c. These buttons allow the user to select the audio output components that will receive the audio output signal generated by hub assembly 28 (FIG. 1) as a result of the communication between satellite receiver 30f and satellite 32f (FIG. 1). For instance, Audio 1 touch button 37a corresponds to audio speakers 36 (FIG. 1). Audio 2 touch button 37b corresponds with a second audio output device, such as wireless headphones 36b (FIG. 1). Audio 3 touch button 37c corresponds to a third audio output device, such as another set of wireless headphones (not shown). The user selects one or more of audio destination touch buttons 37a-37c to direct the audio output signal from station 1 of SDARS. This feature allows the user to selectively direct the audio output of satellite receiver 30f. For instance, the user may want the audio output of SDARS station 1 to be directed only to headphones 36b (FIG. 1), and not to speakers 36. In this case, the user would touch Audio 2 touch button 37b. This also allows the user to select a different SDARS station for output to speakers 36 (FIG. 1), by repeating the station selection process and selecting the Audio 1 touch button 37a.

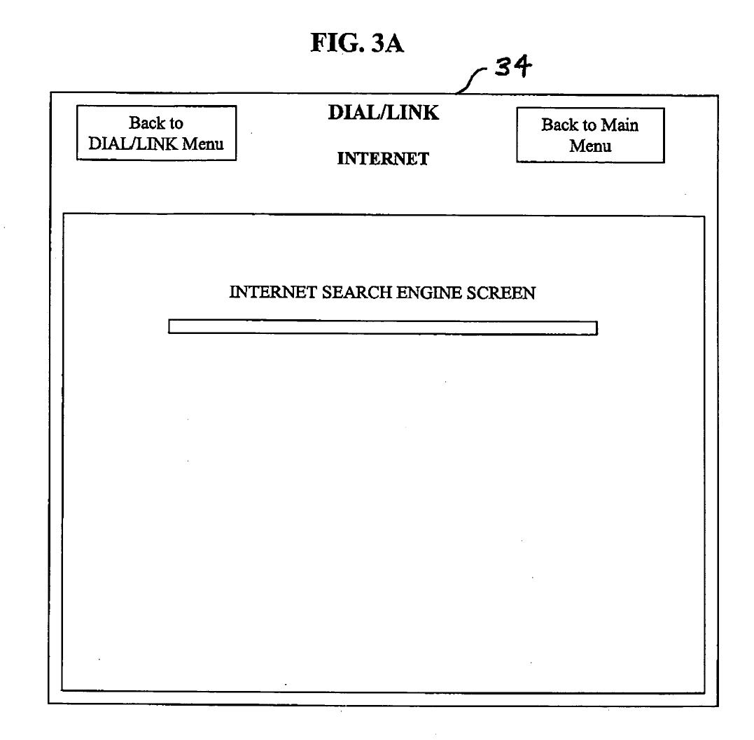

Referring now to FIGS. 2, 3 and 3A, the operation of additional features of an infotainment system in accordance with an embodiment of the present invention will now be described. In this case, we assume that the rear passenger wishes to access the internet while in vehicle 8 (FIG. 1). Using touch screen user interface 34, the user selects the Dial/Link touch button 34e, shown on Main Menu illustrated in FIG. 2. Touch screen user interface 34 then displays the Dial/Link menu shown in FIG. 3.

The Dial/Link menu displays a number of touch buttons corresponding to the options for dialing, or linking to, remote devices, such as cell phones or servers, using wireless communications module 30e (FIG. 1). For instance, wireless communications module 30e (FIG. 1) may be configured to communicatively link to a home computer or home server, such as by using a WiFi and/or Bluetooth connection. Accordingly, the Dial/Link menu may include home server touch button 39a as a menu selection. Wireless communications module 30e (FIG. 1) may also be equipped with a built-in, on-board cellular phone capable of dialing and connecting to remote phones. Accordingly, the Dial/Link menu may have the capacity to store and display phone numbers and contact information for a variety of people and businesses. In this case, the Dial/Link menu may display multiple Contacts touch buttons 39b-39e for navigating through and selecting the contact information. The user would select the Contact touch button 39b-39e corresponding to the first letter in the name of the contact, to retrieve and dial the desired contact. Wireless communications module 30e (FIG. 1) may also be configured to provide internet access, such as by using a built-in, on board cell phone or by using Bluetooth communications with a passenger's cell phone located in the vehicle. Accordingly, the Dial/Link menu may provide Internet touch button 39g for selecting the internet access feature. Wireless communications module 30e (FIG. 1) may also be configured to search for network connections in the area of vehicle 8 (FIG. 1) using WiFi and/or Bluetooth technologies. This allows the user to locate and connect to wireless servers in the area of the vehicle, such as WiFi services offered by cafes, restaurants and bookstores. To this end, the Dial/Link menu may include Search for Network Connection touch button 39h.

The user selects the internet option by touching user interface 34 on Internet touch button 39g. This initiates connection to the internet via wireless communications module 30e (FIG. 1). As discussed above, this may be accomplished through use of a cell phone built into vehicle 8 (FIG. 1), or through WiFi or Bluetooth connection with a cell phone that is separate from the vehicle's infotainment system, but located in or near vehicle 8. Turning to FIG. 3A, upon selecting the Internet touch button 39g, the Dial/Link Internet display is shown on user interface 34. The user may now search the internet. User interface 34 may be equipped with a keyboard (not shown) and/or mouse device to assist the user in navigating the internet.

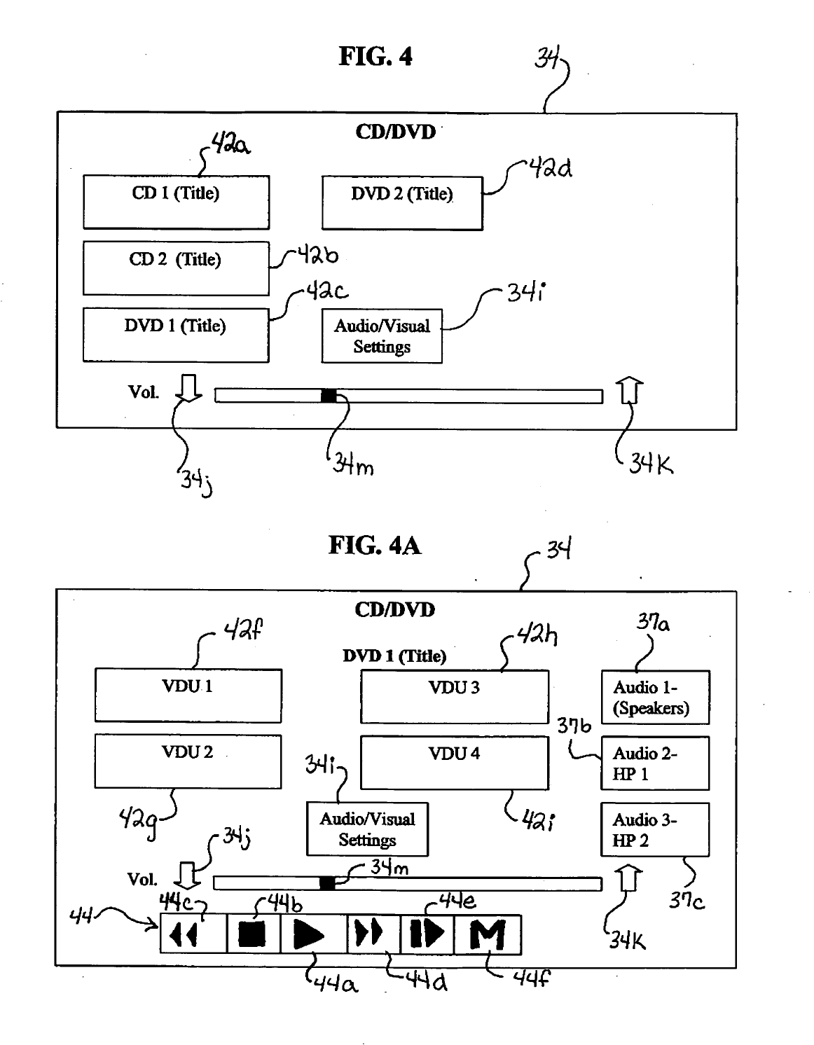

Turning now to FIGS. 2, 4 and 4A, operation of still another feature of an infotainment system of the present invention is illustrated. In this case, we assume that the rear passenger would like to play a DVD in vehicle 8 (FIG. 1). Accordingly, at the Main Menu shown in FIG. 2, the user selects CD/DVD touch button 34a. Upon selecting button 34a, CD/DVD player 30a (FIG. 1) processes/reads information on the CD(s) and DVD(s) loaded in player 30a, and information regarding each CD and DVD is displayed on CD/DVD menu shown in FIG. 4. The CD/DVD Menu includes a touch buttons 42a-42d corresponding to each of the CD/DVDs available in player 30a. Touch buttons 42a and 42b correspond to CD 1 and CD2, respectively, and each of buttons 42a, 42b may list the title of the corresponding CD. Touch buttons 42c and 42d correspond to DVD 1 and DVD 2, respectively, and each of buttons 42c, 42d may list the title of the corresponding DVD.

Assuming the user would like to watch DVD 1, the user selects DVD 1 touch button 42c, which causes the CD/DVD-DVD 1 menu to be displayed on user interface 34, as shown in FIG. 4A. This menu provides a button 42f-42i corresponding to each of the video display units 38 in vehicle 8 (FIG. 2), and allows the user to select which of video display units 38 (FIG. 1) should receive the video output signal produced by CD/DVD player 30a (FIG. 1). Similarly, the CD/DVD-DVD 1 menu provides buttons 37a-37c, discussed above, to allow the user to select which audio unit should receive the audio output signal produced by CD/DVD player 30a. This allows the user to selectively direct the video and audio output signals to specific video display units and audio units, and to simultaneously direct different video and audio output signals to different display units and audio units. The CD/DVD-DVD 1 menu also displays DVD control panel 44, which includes touch buttons useful in the operation of DVD player 30a (FIG. 1). For example, control panel 44 includes play button 44a, stop button 44b, rewind button 44c, forward button 44d, pause button 44e and DVD menu button 44f.

It should be understood that the hierarchy illustrated in the menus shown in FIGS. 2, 2A-2B, 3, 3A, 4 and 4A are merely illustrative of the operation of the menu driven touch screen user interface 34. The menu may include a variety of hierarchies through which a user may navigate and make selections. For instance, the audio and video components (speakers 36, headphones 36b and visual display units 38) may be selected first. That is, the Main Menu may allow the user to first select the destination for the audio and video output signals, and then select which entertainment platform 30a-30f (FIG. 1) should direct its audio and/or video output signals to the selected audio and video components.

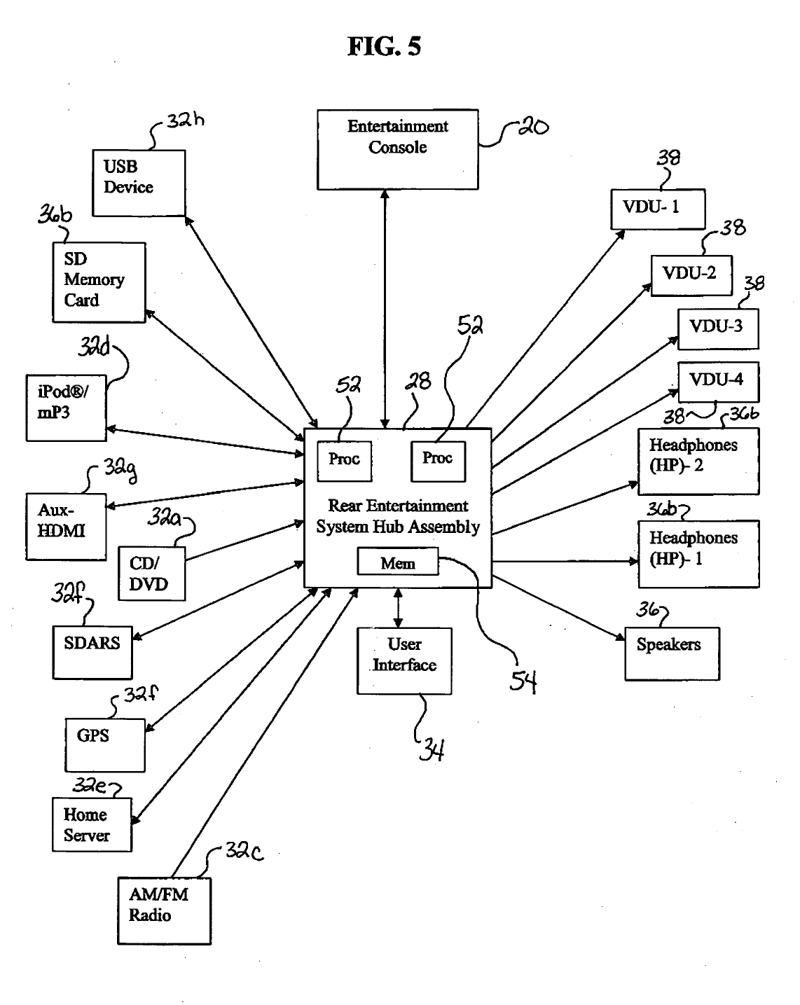

Referring to FIG. 5, a diagram of the communication between rear entertainment system hub assembly 28, entertainment media 32a-32f, user interface 34, video display units 38, audio units 36 and 36b, and entertainment console 20. As illustrated, hub assembly 28 is adapted to exchange information with entertainment media 32a-32f. Hub assembly 28 also exchanges information with user interface 34. More particularly, as noted above, hub assembly 28 receives commands from user interface 34 and processes entertainment media 32a-32h based on the commands received from user interface 34. Hub assembly 28 also transmits video signals generated by the operation of entertainment media 32a-32h to one or more of video display units 38. Hub assembly transmits audio output signals generated by the operation of entertainment media 32a-32h to one or more of speakers 36 and headphones 36b. Hub assembly 28 may be adapted to communicate with front entertainment console 20. In this case, hub assembly 28 may exchange information with entertainment console 20 to determine or control vehicle features such as vehicle condition or vehicle climate control. With hub assembly 28 positioned in the rear space 12b of vehicle 8 (FIG. 1), the rear passengers are provided with convenient access to a variety of entertainment platforms and features, and can exercise control over the operation of the platforms easily.

As illustrated in FIG. 5, hub assembly 28 may also be equipped with one or more processors 52 to assist in the processing, direction and playback by entertainment platforms 30a-30f (FIG. 1). Processors 52 may be configured to operate independent from one another to allow rear passengers to simultaneously enjoy multiple entertainment platforms 30a-30f. Hub assembly 28 may also include a memory storage unit 54 for receiving and storing data, such as data downloaded from remote sources 32e, media files, station presets and other data.

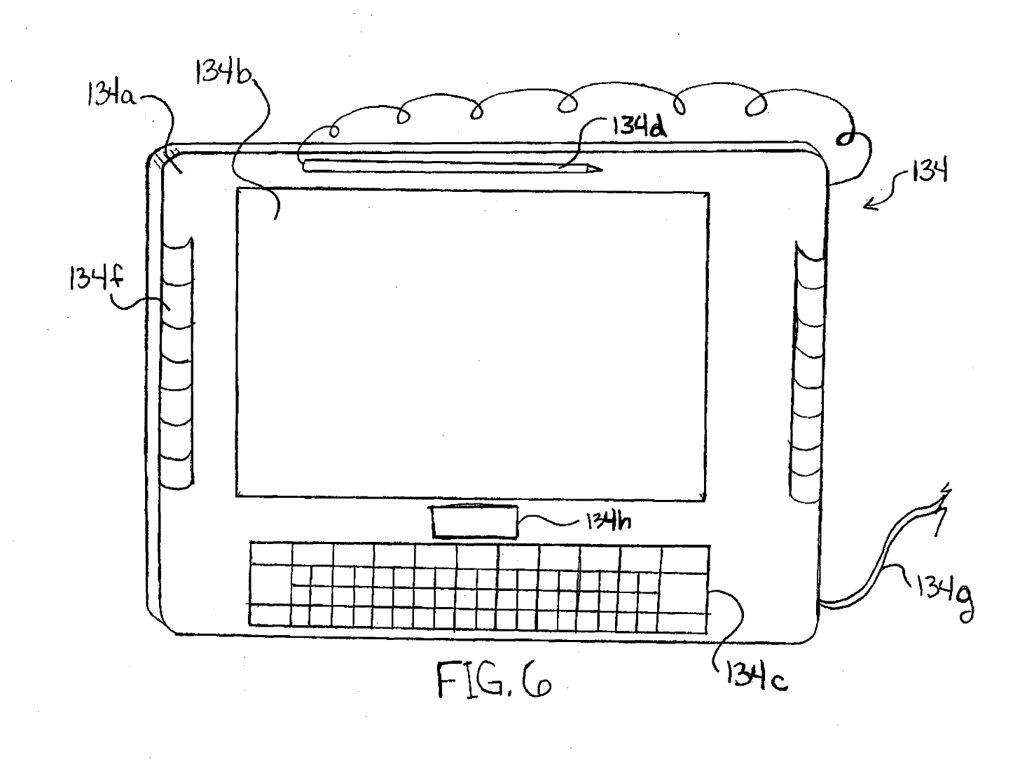

Turning now to FIG. 6, user interface 134 operable in one embodiment of an infotainment system of the present invention is shown. User interface 134 may be communicatively coupled to the hub assembly of the infotainment system by hard wire, or by wireless communication technology such as WiFi, Bluetooth or infra-red. User interface 134 may be powered by a battery or by the electrical connection to the vehicle's electrical system. User interface 134 generally includes housing 134a and touch screen 134b mounted on housing 134a. Touch screen 134b allows a user to navigate through menus and operate the entertainment platforms by touching menu options displayed on touch screen 134b. User interface 134 may also include keyboard 134c, stylus 134d and/or touch mouse pad 134h, which the user may use to make selections on the menus displayed on touch screen 134b. Housing 134a may include gripping portions 134f or handles to assist the user in holding user interface 134. To prevent the user from losing interface 134, housing 134a may be tethered to the hub assembly (not shown) by tether 134g. If user interface 134 is powered by the vehicle electrical system, tether 134g may house the necessary electrical wires. In addition, if user interface 134 is communicatively coupled to the hub assembly by hard wire connection, the necessary communication wires may be housed in tether 134g.

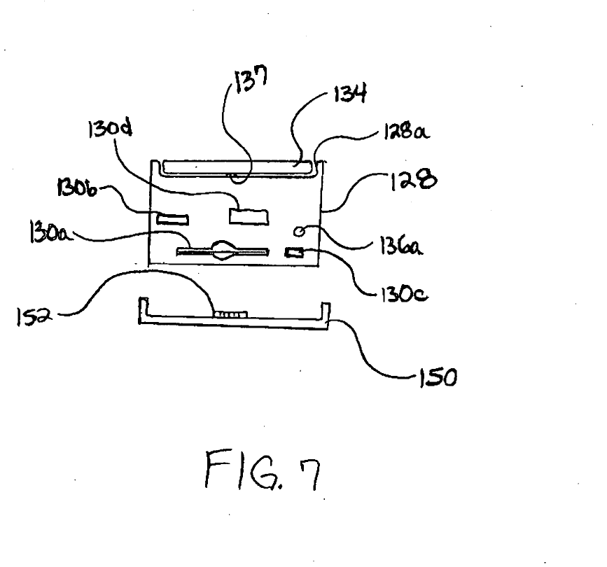

Referring to FIG. 7, one embodiment of the infotainment system is configured such that hub assembly 128 and user interface 134 are portable and may be easily removed from the vehicle. Hub assembly 128 includes entertainment platforms 130a-130d, including CD/DVD player 130a, USB port 130b, iPod® docking port 130c and HDMI port 130c. Hub assembly 128 also includes headphone jack 136a. Hub assembly 128 includes recess 128a, which is configured to receive user interface 134. Interface connector 137 is disposed within recess 128a and is adapted to couple with a mating port (not shown) in user interface 134 to electrically and/or communicatively couple user interface 134 to hub assembly 128. User interface 134 may be configured to snap fit into recess 128a of hub assembly 128, and be removable from recess 128a to allow passengers to operate entertainment platforms 130a-130d of hub assembly 128 from the comfort of their seats. Hub assembly mounting bracket 150 is configured to be mounted to the floor (not shown) of a vehicle (not shown) and to receive communication and electrical conduits (not shown), which feed into connector 152. Hub assembly 128 is removably mountable on bracket 150 to thereby mount hub assembly 128 to the vehicle, and communicatively and electrically couple hub assembly 128 to the vehicle. Hub assembly 128 may be easily removed from bracket 150 to allow the user to use hub assembly 128 in other vehicles or in the home.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An infotainment system for use in a vehicle, the vehicle having a body defining an interior space, front passenger seating disposed within a forward portion of the interior space and rear passenger seating disposed within a rear portion of the interior space, the rear portion being positioned rearward of the forward portion, the infotainment system comprising:
a rear entertainment system hub assembly disposed within the rear portion of the interior space, the rear entertainment system hub assembly including:
a plurality of entertainment platforms each adapted to receive and process a respective entertainment medium, said plurality of entertainment platforms configured to generate at least one audio output signal and at least one video output signal; and
a user interface communicatively coupled to said plurality of entertainment platforms, said user interface including a touch-screen display unit adapted to receive user commands, said user interface selecting and controlling said plurality of entertainment platforms according to said user commands;
a plurality of audio output speakers communicatively coupled to said rear entertainment system hub assembly and receiving said audio output signal; and
at least one video display unit disposed within the rear portion of the interior space, said at least one video display unit receiving said video output signal.

2. The infotainment system of claim 1 wherein said plurality of entertainment platforms includes at least one communication port.

3. The infotainment system of claim 2 wherein said communication port is a USB port.

4. The infotainment system of claim 1 wherein said plurality of entertainment platforms includes a wireless communications module.

5. The infotainment system of claim 1 wherein said plurality of entertainment platforms includes a DVD player.

6. The infotainment system of claim 1 wherein said plurality of entertainment platforms includes a satellite receiver.

7. The infotainment system of claim 1 wherein said plurality of entertainment platforms includes a navigational system, said navigational system being configured to communicate with a global positioning satellite.

8. The infotainment system of claim 1 wherein said at least one video display unit includes multiple video display units, and said plurality of entertainment platforms is configured to generate multiple video output signals, said multiple video output signals being independent of one another, each of said video display units being configured to receive a different one of said multiple video output signals.

9. The infotainment system of claim 1 wherein said user interface is an LCD touch screen, said entertainment system hub assembly configured to display an interactive menu on said LCD touch screen, and said touch screen being detachable from said entertainment system hub assembly.

10. The infotainment system of claim 1 further including an entertainment console in the forward portion of the interior volume, said entertainment console being communicatively coupled to said rear entertainment system hub assembly.

11. A method for providing in-vehicle entertainment to rear passengers of a vehicle; the method comprising the steps of:
installing a rear entertainment system hub assembly within a rear portion of an interior space of the vehicle;
equipping the rear entertainment system hub assembly with a plurality of entertainment platforms each receiving and processing a respective type of entertainment medium, and a user interface communicatively coupled to the plurality of entertainment platforms and receiving user commands;
using the rear entertainment system hub assembly to select and control the plurality of entertainment platforms according to the user commands;
using the rear entertainment system hub assembly to independently and simultaneously operate first and second ones of the plurality of entertainment platforms in response to the user commands, and to generate first and second audio/video output signals from the respective operation of the first and second simultaneously operating entertainment platforms, each of the first and second audio/video output signals comprising at least one of an audio signal and a video signal;
communicatively coupling first and second audio/video output units to the rear entertainment system hub assembly, the audio/video output units comprising at least one of a video display monitor, an audio speaker, and an audio headphone set; and
using the rear entertainment system hub assembly to send the first audio/video output signal to the first audio/video output unit and the second audio/video output signal to the second audio/video output unit.

12. The method of claim 11 wherein said step of equipping the rear entertainment system hub assembly with a plurality of entertainment platforms includes equipping the rear entertainment system hub assembly with a USB communication port.

13. The method of claim 12 wherein the user interface includes a menu-driven touch screen display unit.

14. The method of claim 11 wherein said step of equipping the rear entertainment system hub assembly with a plurality of entertainment platforms includes equipping the rear entertainment system hub assembly with a wireless communications module.

15. The method of claim 11 wherein said step of equipping the rear entertainment system hub assembly with a plurality of entertainment platforms includes equipping the rear entertainment system hub assembly with a DVD player.

16. The method of claim 11 wherein said step of equipping the rear entertainment system hub assembly with a plurality of entertainment platforms includes equipping the rear entertainment system hub assembly with a satellite receiver.

17. The method of claim 11 wherein said step of equipping the rear entertainment system hub assembly with a plurality of entertainment platforms includes equipping the rear entertainment system hub assembly with an mP3 player docking port.

18. The method of claim 11 wherein the user interface is an LCD touch screen, the method comprising the further steps of:
displaying an interactive menu on the LCD touch screen; and
detaching the touch screen from the entertainment system hub assembly.

19. The method of claim 11 further including the step of installing an entertainment console in a forward portion of the interior space of the vehicle and communicatively coupling the entertainment console to the rear entertainment system hub assembly.

20. A method for providing in-vehicle entertainment to rear passengers of a vehicle; the method comprising the steps of:
installing a rear entertainment system hub assembly within a rear portion of an interior space of the vehicle;
equipping the rear entertainment system hub assembly with a plurality of entertainment platforms each receiving and processing a respective type of entertainment medium, and a touch-screen user interface communicatively coupled to the plurality of entertainment platforms and receiving user commands;
using the rear entertainment system hub assembly to select and control the plurality of entertainment platforms according to the user commands;
using the rear entertainment system to generate at least one audio output signal and at least one video output signal in response to the user commands;
communicatively coupling a plurality of audio output speakers to the rear entertainment system hub assembly;
providing at least one video display unit within the rear portion of the interior space of the vehicle and communicatively coupling the at least one video display unit to the rear entertainment system hub assembly;
equipping the rear entertainment system hub assembly with a wireless communication module; and
transferring information between the rear entertainment system hub assembly and a personal electronic device external to the vehicle using the wireless communication module.
